(19) United States
(12) Patent Application Publication
(10) Pub. No.: US 2015/0128769 A1
(43) Pub. Date: May 14, 2015

(54) SPANNER WRENCH

(71) Applicants: Alyssa L. Albrecht, Hales Corners, WI (US); Andrew Block, Menomonee Falls, WI (US)

(72) Inventors: Alyssa L. Albrecht, Hales Corners, WI (US); Andrew Block, Menomonee Falls, WI (US)

(73) Assignee: A & E INCORPORATED, Racine, WI (US)

(21) Appl. No.: 14/539,427

(22) Filed: Nov. 12, 2014

Related U.S. Application Data
(60) Provisional application No. 61/903,629, filed on Nov. 13, 2013.

(51) Int. Cl. B25B 13/42; B25B 13/50

(52) U.S. Cl. CPC B25B 13/42; B25B 13/50
USPC 81/99

(57) ABSTRACT

An adjustable spanner wrench which maintains a predetermined engagement position. The spanner wrench has a rotatable engagement arm attached to a body, wherein the engagement arm is discouraged from rotating in an opening direction unless released. The spanner wrench has a body, an engagement arm, and a release mechanism which allows or prevents rotation of the engagement arm respective to the body in the opening direction.

### RELATED APPLICATIONS

This application claims the benefit of co-pending U.S. Provisional Patent Application Ser. No. 61/903,629, filed 13 Nov. 2013, and entitled “Spanner Wrench.”

### BACKGROUND OF THE INVENTION

Wrenches, specifically spanner wrenches are well known to those in the art. Spanner wrenches come in a variety of sizes and shapes, and employing different interfacing means including pins and hooks. Some spanner wrenches are adjustable by employing a freely pivoting arm. This type of spanner wrench accommodates various sized connectors; however, as it pivots freely, it will not maintain a certain engagement position. This can be frustrating when loosening or tightening a part in a hard to reach place or in an area where the part can only be accessed from a certain direction wherein the spanner wrench opens on its own making it difficult to reattach between active turns. Accordingly, the art of spanner wrenches could benefit from a spanner wrench that is both adjustable and capable of maintaining its engagement position.

### SUMMARY OF THE INVENTION

The present invention relates to an adjustable spanner wrench which maintains an engagement position. It further contemplates a biased release which, when activated, allows the spanner wrench to open and close freely.

One object of the provides a spanner wrench having a body with a first end, a second end, and a cut-out section extending inwardly from the second end; an engagement arm rotatably attached to the body at or near the second end of the body; a release mechanism rotatably attached to the body, substantially enclosed within the cut-out section, and biased in a first direction; and whereby, when biased in the first direction, the release mechanism is engaged with the engagement arm and when a force is applied to the release mechanism in a second direction, substantially opposite the first direction, the release mechanism is disengaged from the engagement arm.

The release mechanism may have a tab and the body may have a window through which the tab extends. The engagement arm may have a hook-type profile and may further have a distal end with a recess and a pin extending outward therefrom.

The body may have a first layer, a second layer, and a third layer, the second layer positioned between the first and third layers and having the cut-out section therein. The first, second, and third layers of the body may be secured together by rivets.

The engagement arm may have a first layer, a second layer, and a third layer, the second layer positioned between the first and third layers and whereby the second layer is configured to be rotatably attached to the body. The first, second, and third layers of the engagement arm may be secured together by rivets.

Another aspect of the invention provides a spanner wrench with a body having a first end, a medial portion with a cut-out section and a window, and a second end; the cut-out section has a first side and a second side; an engagement arm rotatably attached to the body at or near the second end of the body having a proximal end and a distal end, the proximal end with a peripheral edge and teeth extending outwardly from the peripheral edge; a release mechanism having a first section, a second section, a first end with a tab, a medial portion, and a second end with teeth extending outwardly therefrom; the release mechanism positioned within the cut-out section with the teeth of the release mechanism extending outward therefrom and the tab extending through the window; the release mechanism rotatable about a pivot member placed through the medial section of the body and the medial portion of the release mechanism; a biasing member placed between the first side of the cut-out section and the first section of the release mechanism, the biasing member applies a biasing force to the release mechanism positioning the first section of the release mechanism adjacent to the second side of the cut-out section and the second section of the release mechanism adjacent to the first side of the cut-out section, whereby the teeth of the release mechanism are engaged with the teeth of the engagement arm prohibiting the distal end of the engagement arm from rotating away from the body; and whereby, when a force is applied to the tab in a direction opposite the biasing force, the release mechanism rotates about the pivot member and the teeth of the release mechanism disengage from the teeth of the engagement arm allowing the engagement arm to rotate freely.

The engagement arm may have a hook-type profile. Additionally or alternatively, the engagement arm may have a recess in the distal end and a pin extending outwardly therefrom.

The body may have a first layer, a second layer, and a third layer, the second layer positioned between the first and third layers and having the cut-out section therein. The first, second, and third layers of the body may be secured together by rivets.

The engagement arm may have a first layer, a second layer, and a third layer, the second layer positioned between the first and third layers and whereby the second layer has the peripheral edge and the teeth extending therefrom and is configured to be rotatably attached to the body. The first, second, and third layers of the engagement arm may be secured together by rivets.

The first side of the cut-out section may have a pocket in which the biasing member is located.

### BRIEF DESCRIPTION OF THE DRAWINGS

FIG. 1 is a perspective view of a spanner wrench according to the present invention.

FIG. 2 is an exploded view of the spanner wrench shown in FIG. 1.

FIG. 3A is a perspective view of a first embodiment of a pin-type engagement arm according to the present invention.

FIG. 3B is a perspective view of a second embodiment of a pin-type engagement arm according to the present invention.

FIG. 4 is a partial-section view of the spanner wrench shown in FIG. 1 along line 4-4.

FIG. 5 is a partial cut-away view of the spanner wrench shown in FIG. 1 illustrating functionality.

FIG. 6 is a partial cut-away view of the spanner wrench shown in FIG. 1 illustrating functionality.

FIG. 7 is a view of the spanner wrench shown in FIG. 1 illustrating functionality.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

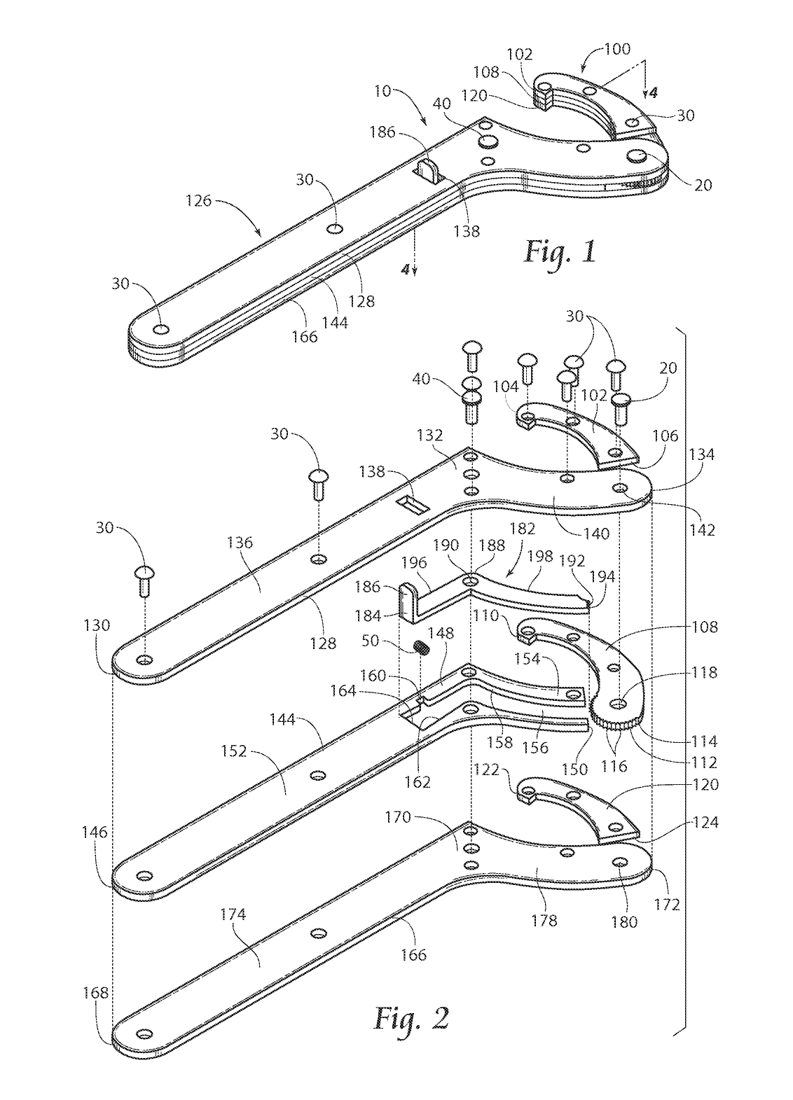

Looking to FIG. 1, the spanner wrench 10 according to the present invention is shown. The spanner wrench 10 comprises an engagement arm 100 rotatably attached to a body 126 by a joint member 20, and a release mechanism 182 (see FIG. 2). The engagement arm comprises a first layer 102, a second layer 108, and a third layer 120. The body 126 comprises a first layer 128, a second layer 144, and a third layer 166. As shown in the drawings, the engagement arm layers (102, 108, and 120) and the body layers (128, 144, and 166) are respectively secured together using rivets 30; however, other securing means may be employed.

FIG. 2 illustrates the spanner wrench 10 in an exploded view. First, looking to the engagement arm 100, the three engagement arm layers (102, 108, and 120) are more easily seen. The first layer 102 has a first end 104 from which it arcuately extends to a second end 106 and defining a hook-type profile. The third layer 120 has a first end 122 and a second end 124 and is substantially similar to the first layer 102 in size and shape. The second layer 108 comprises a distal end 110 and a proximal end 112. The second layer 108 is substantially similar in size and shape to the first layer 102 and the third layer 120 from the first and third layer first ends 104, 122, respectively, to the first and third layer second ends 106, 124, respectively. However, the second layer 108 extends further to the proximal end 112 which comprises a peripheral edge 114 with teeth 116 and an aperture 118 for receiving the joint member 20.

Second, looking to the body 126, the three body layers (128, 144, and 166) are shown. The first layer 128 has a first section 136 extending linearly from a first end 130 to a medial portion 132. The first layer 128 doglegs at the medial portion 132 and continues with a second section 140 extending arcuately from the medial portion 132 to a second end 134. The second section 140 has an aperture 142 near the second end 134 for receiving the joint member 20. Furthermore, the first layer 128 has a window 138 located in the first section 136.

The third layer 166 is substantially similar to the first layer 128. It has a first section 174 extending linearly from a first end 168 to a medial portion 170, a second section 178 extending arcuately from the medial portion 170 to a second end 172 and having an aperture 180. Moreover, the first section 174 may also have a window (not shown) in the same location as the window 138 on the first layer 128.

The second layer 144 comprises a first section 152 extending linearly from a first end 146 to a medial portion 148. The second layer 144 doglegs at the medial portion 148 and continues with a second section 154 extending arcuately from the medial portion 148 to a second end 150. The size and shape of the first section 152 may be substantially similar to the first sections 136, 174 of the first layer 128 and the third layer 166, respectively. The second section 154 maintains a similar shape as the second sections 140, 178 of the first layer 128 and the third layer 166, but terminates short of the first and third layer second ends 134, 172, respectively.

Furthermore, the second layer 154 has a cut-out section 156 having a first side 158, a second side 162, and a terminal end 164. The cut-out section 156 extends from the second layer second end 150 to the second layer medial portion 148, substantially following the same arcuate profile of the second section 154. The cut-out section 156 doglegs at the medial portion 148, partially extends substantially linearly along the second layer first section 152, and ends at the terminal end 164 which is located at approximately the same place along the second layer first section 152 as the window 138 in the first layer first section 136. The cut-out section 156 may also comprise a pocket 160 extending perpendicularly from the first side 158 into the second layer first section 152 near the terminal end 164, in which a biasing member 50 may be placed.

The release mechanism 182 comprises a unitary piece of material comprising a first section 196, a medial portion 188, and a second section 198. The first section 196 is substantially linear and extends between a first end 184 and the medial portion 188. A tab 186 protrudes substantially perpendicularly upward from the first end 184. It should be noted that reference to any direction (up, down, etc.) is in relation to the orientation of the spanner wrench 10 in the figures and should not be construed as limiting.

Furthermore, the release mechanism 182 doglegs at the medial portion 188 into the second section 198. The second section 198 is substantially arcuate and extends from the medial portion 188 to a second end 192. The second end 192 has teeth 194 extending outwardly from the second end 192.

Additionally, an aperture 190 is located in the medial portion 188 of the release mechanism 182. The aperture 190 receives a pivot member 40 for the release mechanism 182 to rotate about.

It should be understood that the three layer arrangement should not be viewed as limiting, as any arrangement capable of achieving that which is set forth may be within the scope of the present invention. For example, the engagement arm 100 may be comprised of one solid piece of material formed or machined into the shape shown and described herein, and the body may be comprised of two pieces, wherein one piece comprises the combined shape and features of the second and third layers 144, 166 and the second piece being similar to the first layer 128.

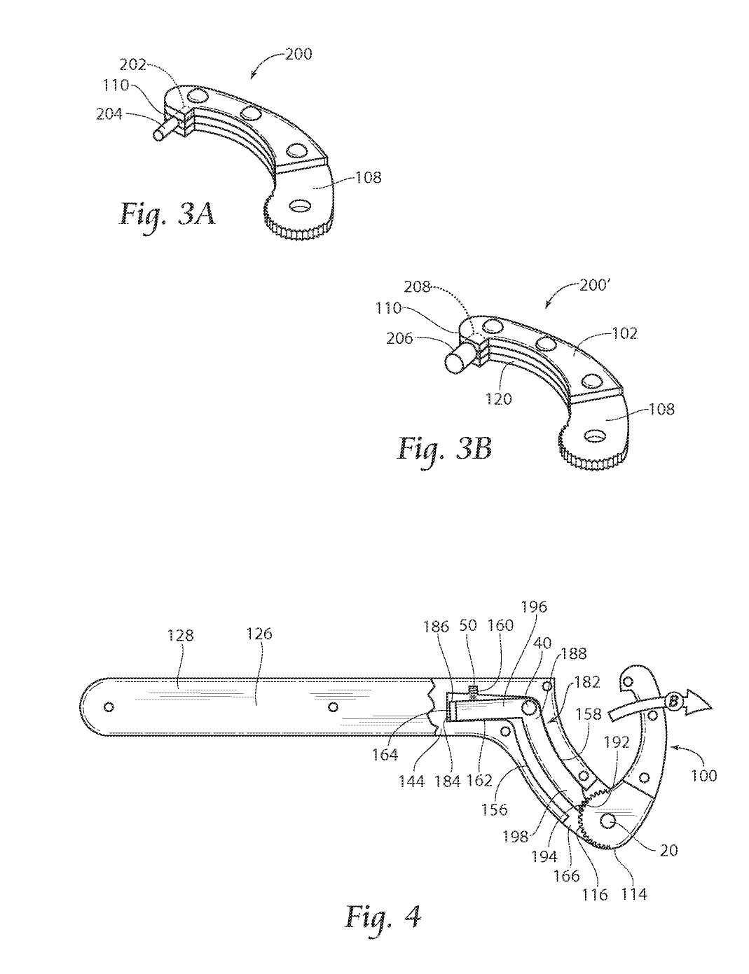

Furthermore, the engagement arm 100 illustrated in FIGS. 1 and 2 is of a hook-type engagement arm. FIG. 3A illustrates the present invention employing a pin-type engagement arm 200. Shown here, the engagement arm second layer 108 may comprise a recess 202 along its distal end 110 to receive a pin 204. A larger pin 206 is also contemplated as shown in FIG. 3B, whereby the first layer 102, the second layer 108, and the third layer 120 may be modified to provide a larger recess 208.

Moving on to FIG. 4 in which a partial-section view of the body 126 is shown as seen along line 4-4 of FIG. 1 and partially displaying the body second layer 144. Here it can be seen that the release mechanism 182 resides in the cut-out section 156 and is affixed to the first body layer 128 and the third body layer 166 by a pivot member 40 placed through the release mechanism aperture 190 (see FIG. 2). The pivot member 40 is sized to allow the release mechanism 182 to pivot about it. Furthermore, a biasing member 50, here depicted as a coil spring, may be placed in the pocket 160 of the cut-out section 156 and in mechanical communication with the release mechanism 182.

Use of the spanner wrench 10 may be seen in FIGS. 5-7. FIG. 5 illustrates release of the engagement arm 100. A user 60 applies a force to the tab 186, accessible via window 138, in the direction of arrow C sufficient to overcome force applied by the biasing member 50. Doing so rotates the release mechanism 182 about pivot member 40 and disengages the release mechanism teeth 194 from the engagement arm second layer teeth 116, thereby allowing the engagement arm 100 to rotate freely in the opening or closing directions about the joint member 20. It is further contemplated that the tab 186, or an extension thereof, may also be accessible through a window (not shown) in the third body layer 166, or through both the first body layer window 138 and the third body layer window (not shown).

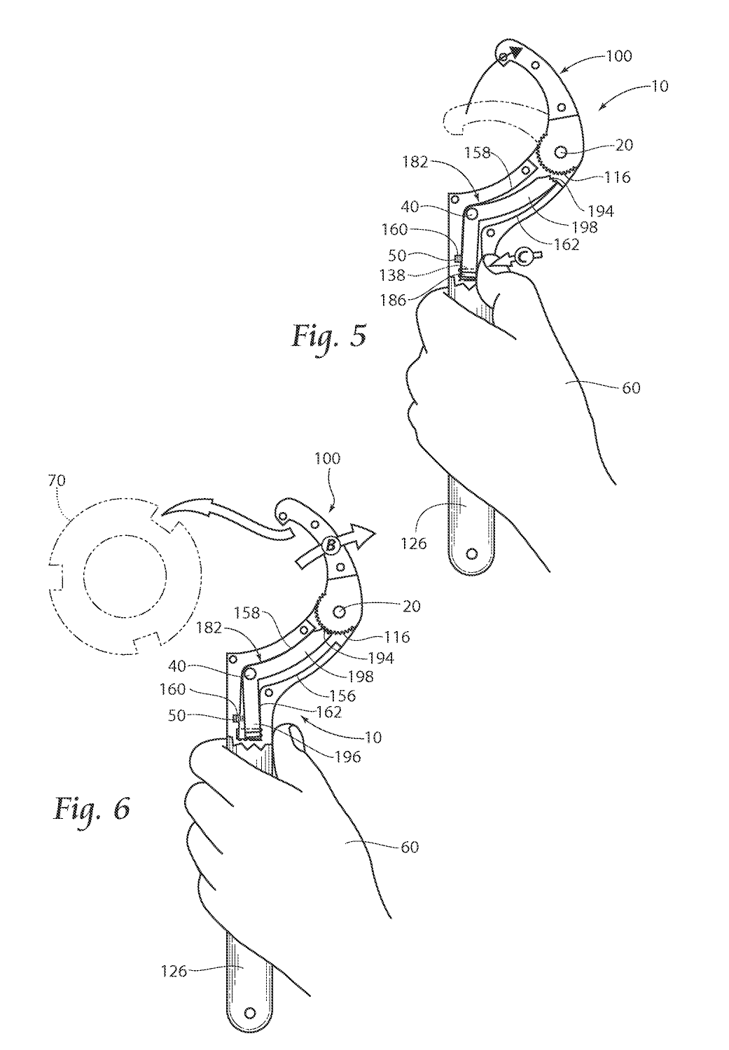

As shown in FIG. 6, the biasing member 50 acts upon the release mechanism 182 and the pocket 160 to bias the first section 196 of the release mechanism 182 against the second side 162 of the cut-out section 156. In this position, the engagement of the release mechanism teeth 194 with the engagement arm second layer teeth 116 in combination with interaction between the release mechanism second section 198 and the cut-out section first side 158, deter movement of the engagement arm 100 in the direction of arrow B.

However, the engagement arm 100 may rotate in the opposite direction of arrow B when a force is applied in that direction (i.e. the closing direction), opposed only by the biasing member 50. The force required to move the engagement arm 100 may be increased or decrease by altering the spring rate and/or location of the biasing member 50.

FIG. 6 further illustrates the spanner wrench 10 approaching a spanner nut 70 from the side and maintaining the position of the engagement arm 100 relative to the body 126.

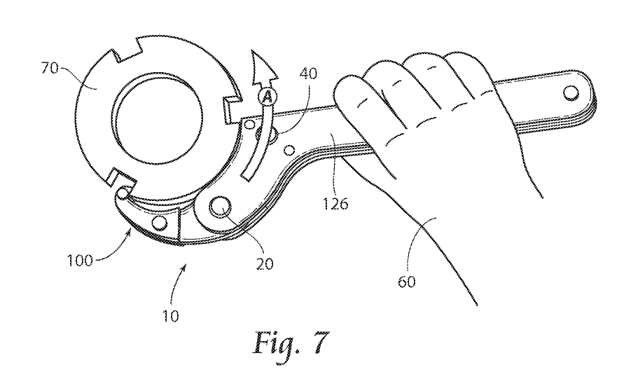

Looking to FIG. 7 the spanner wrench 10 is shown turning a spanner nut 70 in the direction of arrow A, wherein the orientation of the figure is so that the movement towards the top of the page is upward movement. Here, too, the engagement arm 100 may remain in the same position relative to the body 126, and when the user 60 repositions the spanner wrench 10 after a turn, the engagement arm 100 will maintain its position relative to the body 126, and not pivot in the opening direction. Again, this is due to the engagement of the release mechanism teeth 194 with the engagement arm second layer teeth 116 and the interaction between the release mechanism second section 198 and the cut-out section first side 158 (see FIG. 6). Therefore, allowing the spanner wrench 10 to be reengaged with the spanner nut 70 from below with only one hand.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1. A spanner wrench comprising:
a body with a first end, a second end, and a cut-out section extending inwardly from the second end;
an engagement arm rotatably attached to the body at or near the second end of the body;
a release mechanism rotatably attached to the body, substantially enclosed within the cut-out section, and biased in a first direction; and
whereby, when biased in the first direction, the release mechanism is engaged with the engagement arm and when a force is applied to the release mechanism in a second direction, substantially opposite the first direction, the release mechanism is disengaged from the engagement arm.

2. The spanner wrench of claim 1, wherein the release mechanism further comprises a tab and the body further comprises a window through which the tab extends.

3. The spanner wrench of claim 1, wherein the engagement arm comprises a hook-type profile.

4. The spanner wrench of claim 1, wherein the engagement arm further comprises a distal end with a recess and a pin extending outward therefrom.

5. The spanner wrench of claim 1, wherein the body is comprised of a first layer, a second layer, and a third layer, the second layer positioned between the first and third layers and having the cut-out section therein.

6. The spanner wrench of claim 5, wherein the first, second, and third layers of the body are secured together by rivets.

7. The spanner wrench of claim 1, wherein the engagement arm is comprised of a first layer, a second layer, and a third layer, the second layer positioned between the first and third layers and whereby the second layer is configured to be rotatably attached to the body.

8. The spanner wrench of claim 7, wherein the first, second, and third layers of the engagement arm are secured together by rivets.

9. A spanner wrench comprising:
a body having a first end, a medial portion with a cut-out section and a window, and a second end;
the cut-out section has a first side and a second side;
an engagement arm rotatably attached to the body at or near the second end of the body having a proximal end and a distal end, the proximal end with a peripheral edge and teeth extending outwardly from the peripheral edge;
a release mechanism having a first section, a second section, a first end with a tab, a medial portion, and a second end with teeth extending outwardly therefrom;
the release mechanism is positioned within the cut-out section with the teeth of the release mechanism extending outward therefrom and the tab extending through the window;
the release mechanism is rotatable about a pivot member placed through the medial section of the body and the medial portion of the release mechanism;
a biasing member placed between the first side of the cut-out section and the first section of the release mechanism, the biasing member applies a biasing force to the release mechanism positioning the first section of the release mechanism adjacent to the second side of the cut-out section and the second section of the release mechanism adjacent to the first side of the cut-out section, whereby the teeth of the release mechanism are engaged with the teeth of the engagement arm prohibiting the distal end of the engagement arm from rotating away from the body; and
whereby, when a force is applied to the tab in a direction opposite the biasing force, the release mechanism rotates about the pivot member and the teeth of the release mechanism disengage from the teeth of the engagement arm allowing the engagement arm to rotate freely.

10. The spanner wrench of claim 9, wherein the engagement arm comprises a hook-type profile.

11. The spanner wrench of claim 9, wherein the engagement arm has a recess in the distal end and a pin extending outwardly therefrom.

12. The spanner wrench of claim 9, wherein the body is comprised of a first layer, a second layer, and a third layer, the second layer positioned between the first and third layers and having the cut-out section therein.

13. The spanner wrench of claim 12, wherein the first, second, and third layers of the body are secured together by rivets.

14. The spanner wrench of claim 7, wherein the engagement arm is comprised of a first layer, a second layer, and a third layer, the second layer positioned between the first and third layers and whereby the second layer has the peripheral edge and the teeth extending therefrom and is configured to be rotatably attached to the body.

15. The spanner wrench of claim 9, wherein the first, second, and third layers of the engagement arm are secured together by rivets.

16. The spanner wrench of claim 9, wherein the first side of the cut-out section has a pocket in which the biasing member is located.
